(19) United States
(12) Patent Application Publication
(10) Pub. No.: US 2015/0301158 A1
(43) Pub. Date: Oct. 22, 2015

(54) Waveform Selection for Mitigation of Radar Saturating Clutter

(71) Applicant: Terry Lee Foreman, Colonial Beach, VA (US)

(72) Inventor: Terry Lee Foreman, Colonial Beach, VA (US)

(21) Appl. No.: 14/296,297

(22) Filed: Jun. 4, 2014

Related U.S. Application Data
(60) Provisional application No. 61/980,627, filed on Apr. 17, 2014.

(51) Int. Cl. G01S 7/28; G01S 13/524

(52) U.S. Cl. CPC G01S 7/2813; G01S 13/5244

(57) ABSTRACT

A computer-implemented method is provided for maximizing surveillance volume in a radar system. This includes determining saturation range probability f̅ₛₐₜ; determining sensitivity probability fₛₑₙₛ; calculating surveillance volume from multiplying the saturation range probability by the sensitivity probability as Vₛ= f̅ₛₐₜ·fₛₑₙₛ; and adjusting the radar system to maximize the surveillance volume.

### CROSS REFERENCE TO RELATED APPLICATION

Pursuant to 35 U.S.C. §119, the benefit of priority from provisional application 61/980,627, with a filing date of Apr. 17, 2014, is claimed for this non-provisional application.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention relates generally to providing mitigation of dynamic range overload in radars. In particular, the invention maximizes track and detection ranges when there is overloading or saturating at the radar receiver from clutter or large targets.

Ground clutter and large targets produce large amplitude signals at the radar receiver. If the amplitude of the signals exceeds the dynamic range of the receiver then the data output from the receiver is unreliable. Subsequent signal processing of the unreliable data further expand the range extent of unreliable data. Under such circumstances, range gates can occur rendering the radar becoming blind, thereby precluding detection of a target.

For example, if a single large amplitude scatterer with a length of 100 feet were to cause receiver saturation for a 10% duty radar then 20% of all range gates would have unreliable data and be incapable of reliably detecting targets. Thus for a radar searching to 100 miles would be blind for 20 miles of the 100 miles even though the length of the target is just 100 feet.

The reason that a single saturating target can have such an adverse influence is that the saturation time is extended by the pulse width of the radar in the receiver causing the loss of 10% of the range space. The subsequent signal processing of the unreliable data is stretched by the matched filter producing total of 20% unreliable data.

### SUMMARY

Conventional radar waveform selections are designed to maximize detectability without regard to the effects of saturation and therefore yield disadvantages addressed by various exemplary embodiments of the present invention. In particular, a method is provided for maximizing surveillance volume in a radar system that also accounts for saturation. This is accomplished by determining saturation range probability f̅ₛₐₜ for each waveform and processing option; determining sensitivity probability fₛₑₙₛ for each waveform and processing option; calculating surveillance volume probability by multiplying the saturation range probability by the sensitivity probability as Vₛ= f̅ₛₐₜfₛₑₙₛ; and selecting the waveform and processing option that maximizes the surveillance volume probability.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1 is a timeline view of a range gate for a radar transmission pulse;

FIG. 2 is a timeline view of a series of range gates;

FIG. 3 is a graphical view of effect of range to sensitivity;

FIG. 4 is a tabular view of first example of a single saturating scatterer;

FIG. 5 is a tabular view of a second example of five non-overlapping scatters with 10 dB of saturation;

FIG. 6 is a tabular view of a third example of five non-overlapping scatters with 10 dB of saturation;

FIG. 7 is a graphical view of detection versus duty for one scatterer with 10 dB saturation;

FIG. 8 is a graphical view of detection versus sensitivity for one scatterer with 10 dB saturation;

FIG. 9 is a graphical view of detection versus duty for five non-overlapping scatterers with 10 dB saturation;

FIG. 10 is a graphical view of detection versus sensitivity for five non-overlapping scatterers with 10 dB saturation;

FIG. 11 is a graphical view of detection versus duty for five non-overlapping scatterers with 6 dB saturation; and

FIG. 12 is a graphical view of detection versus sensitivity for five non-overlapping scatterers with 6 dB saturation.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

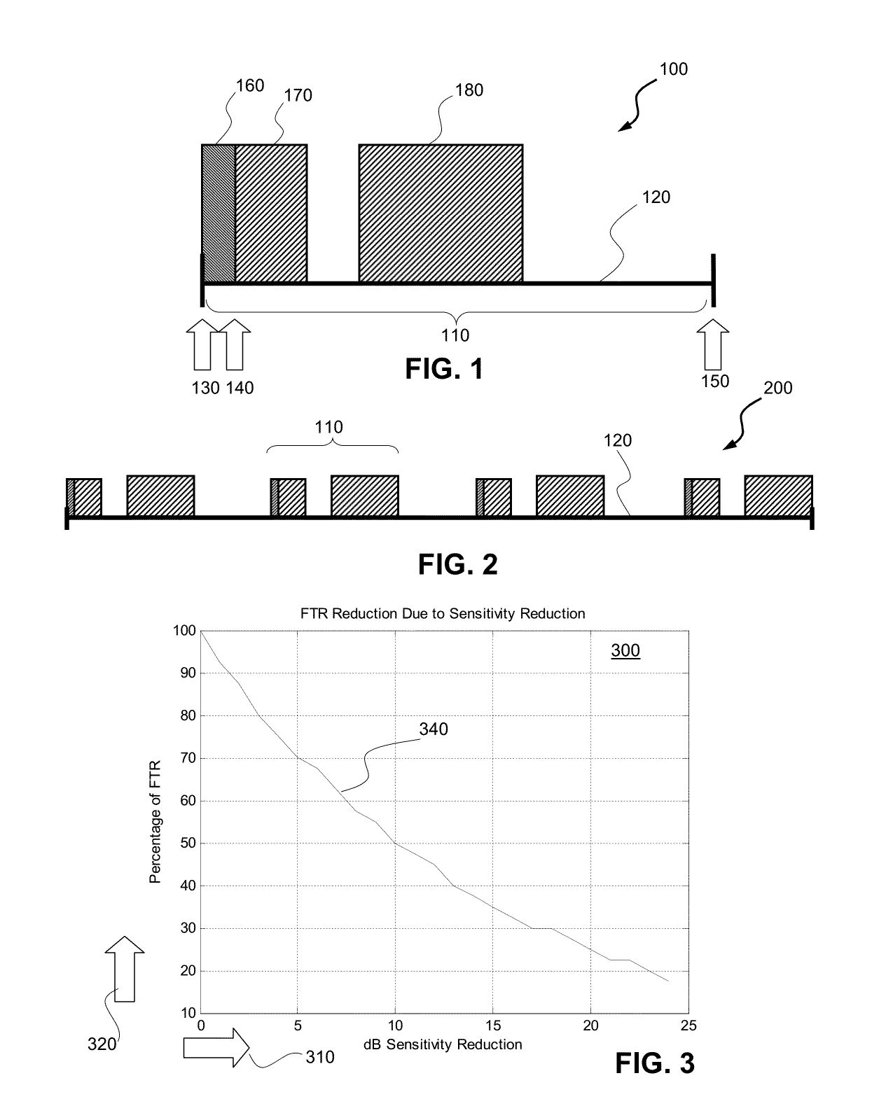

FIG. 1 shows a timeline view 100 of Inter Pulse Period (IPP) and the saturation effect. A chronometric interval 110 represents the effective period of a timeline 120. This time corresponds to range in that radar systems determine range-to-target based on the time required to receive the target echo. The interval 110 begins at start 130 until reaching minimum range 140 and continues until end 150. A recovery cell 160 for the radar extends from the start 130 to the minimum range 140, followed by a saturation periods 170 and 180, separated by a gap. Thus 160 is the period of time the radar receiver is gated off to allow for the transmit time and receiver recovery time. Target detection is impossible in 160. Signal saturation seriously reduces sensitivity in the range gate, e.g., the interval 110 the saturation occurs within. This renders detection of targets in those range gates virtually impossible.

The diagram view 100 shows the ranges that the radar is saturated and thus cannot detect targets. In this example 170 and 180 indicate saturation regions where detection of targets would be impossible. The likely source of saturation is clutter at near range, as clutter at longer ranges does not saturate the radar receiver. However, because the radar can employ multi-pulse Doppler processing, the saturated ranges fold out impacting target detection at longer ranges. These processing techniques include Moving Target Indicator (MTI), Moving Target Detector (MTD), or Pulse Doppler (PD).

FIG. 2 shows an expanded timeline view 200 of repeating intervals 110 within the timeline 120, where 120 is the unambiguous range. Although saturation usually occurs at close ranges, these blind ranges fold out because the IPP is ambiguous in range. Thus for IPP being X % saturated, the radar has lost that corresponding fraction of its entire surveillance volume. View 200 illustrates why short range clutter can cause long range targets to not be detected. For example, assume the first IPP has inhibited detections for 40% of its range gates. This IPP may only cover minimum range to say 10 nm. However, due to folding affects, targets at ranges longer than 10 nm may not be detected.

Various exemplary embodiments minimize the reduction of detection range and surveillance volume caused by receiver saturation due to clutter (and possibly slows moving targets). This technique applies changes in the radar waveforms and attenuators in an optimum manner. This technique may often be applied by only software changes to the radar.

Designing radars with sufficient dynamic range such that their receivers will never be overloaded or saturated remains beyond the current state of the art. As a consequence, ground based radars may find themselves in situations where ground clutter causes the radar receiver to be saturated. In that situation, there will be range gates where the radar is blind. Saturation severely reduces sensitivity in the affected range gates, rendering detection of targets in those range gates virtually impossible.

Currently, radars will modify their waveforms, attenuators or transmitter power output to reduce the volume of space that is affected by saturation. This may be accomplished by manual or automatic techniques. These changes reduce the regions where the radar is blind. However, changes to waveforms, attenuators or transmitter power output reduce the radar's sensitivity. This in turn reduces maximum firm track range (FTR) and surveillance volume. Heretofore, there has been no conventional technique to conduct a proper tradeoff between reduction of saturation and sensitivity reduction that maximizes radar performance in saturating clutter environments.

There are two key elements to the exemplary embodiments. The first is the control strategy of applying waveform duty changes and other changes that maximizes the surveillance volume for a specified size and speed target. The second is using multiple instances of Pulse Repetition Frequency (PRF) that minimize overlapping blind ranges on subsequent looks.

The control strategy is achieved by using two probabilities for maximizing surveillance volume Vₛ of radar detection performance. The first parameter denotes the probability that any target in the surveillance volume will not overlap with saturating clutter. This parameter f̅ₛₐₜ can be identified as the negation of saturation range probability fₛₐₜ. This non-saturation parameter f̅ₛₐₜ can also be conceived as the fraction of range cells that are unaffected by saturation. As changes are made in the radar's settings to reduce sensitivity, non-saturation probability f̅ₛₐₜ increases, indicating that there are fewer saturated range cells to inhibit target detection. FIG. 1 illustrates f̅ₛₐₜ as a timeline denoting the percentage of range not contained in 170 and 180.

The other value to be computed represents the probability that the target (corresponding to a specified size and speed) will be detected and tracked as fₛₑₙₛ, while ignoring saturation yet considering the sensitivity reduction due to radar setup changes. The sensitivity probability fₛₑₙₛ indicates the fraction of detection range that remains based on sensitivity reductions employed to reduce saturation.

FIG. 3 illustrates fₛₑₙₛ as a plot of FTR in response to sensitivity reduction. The abscissa 310 identifies quantity of desensitization applied to the radar to mitigate saturation. The ordinate 320 denotes the value of fₛₑₙₛ as the percentage of FTR retained. Response line 330 illustrates corresponding diminution in FTR with greater sensitivity reduction. For example, FTR is 100 at 0 dB but reduces to 50% at 10 dB.

Based on this information, the probability that a target at any range cell in the surveillance volume will be put into track is computed as:

Vₛ= f̅ₛₐₜfₛₑₙₛ, (1)

where surveillance volume represents a product of the non-saturation probability and the sensitivity.

The exemplary control strategy is to maximize eqn. (1) for all possible settings of waveforms, attenuators and transmitter power settings. The surveillance volume Vₛ considers the reduction in saturation that increases surveillance volume and the decrease in FTR caused by the sensitivity decrease required to diminish saturation.

The proper trade-off of sensitivity reduction with reduction in saturation of the radar can be accomplished by eqn. (1). This control strategy is optimum for a specified target size, and thus suboptimum for targets larger or smaller than the specified size. Therefore, the control is usually set for the smallest and/or fastest target that the radar must track because suboptimum performance for larger and/or slower targets is usually more tolerable.

The relation for eqn. (1) is based on the assumption that f̅ₛₐₜ and fₛₑₙₛ constitute independent probabilities. This is justified under the condition that targets can be at any range cell and that the pulse repetition frequencies (PRFs) of the various waveforms have blind ranges that minimize overlap.

Radars often incorporate multiple PRFs to render a Firm Track decision. Additionally, radars often use different PRFs on subsequent searches in a given direction. This element requires that the radar using multiple PRFs be selected so as to minimize the blind range overlap between all PRFs. This guarantees the independence of the probabilities f̅ₛₐₜ and fₛₑₙₛ. In addition it guarantees that that f̅ₛₐₜ is independent from search to search. Non-saturation probability f̅ₛₐₜ can be treated as independent between searches to ensure that if a target is missed on a first pass that there remains a probability of being observed and detected on the next sweep of non-saturation probability f̅ₛₐₜ. Otherwise, missing a target on the first sweep would render likely continued non-detection on subsequent passes, until the target moved into range cells that were not saturated.

As an example consider a hypothetical radar that employs 10% duty waveforms. Further, this radar can reduce duty to 5% or 1% with the associated sensitivity loss if required to mitigate saturation. In addition, the radar can reduce its transmitted power by 8 dB to mitigate saturation. Based on the radar's transition to track policy and specified target size and speed, the reduction in FTR associated with sensitivity reduction as given in view 100 as a function of sensitivity reduction. FIG. 3 shows a plot 300 of FTR in relation to Sensitivity. The reduced sensitivity (in decibels) constitutes the abscissa 310 and the FTR percentage represents the ordinate 320. A negative slope line 330 shows that as sensitivity reduction is applied to mitigate saturation FTR decreases. The sensitivity fₛₑₙₛ can be read off ordinate 320.

Three cases can be considered. For the first case, there is one scatter that has an amplitude that is 10 dB above the saturation limit of the radar. Because the radar has 10% duty, the point scatter saturates the radar over 10% of the range space before pulse compression. After pulse compression the saturated range cells will be doubled taking 20% of the range space.

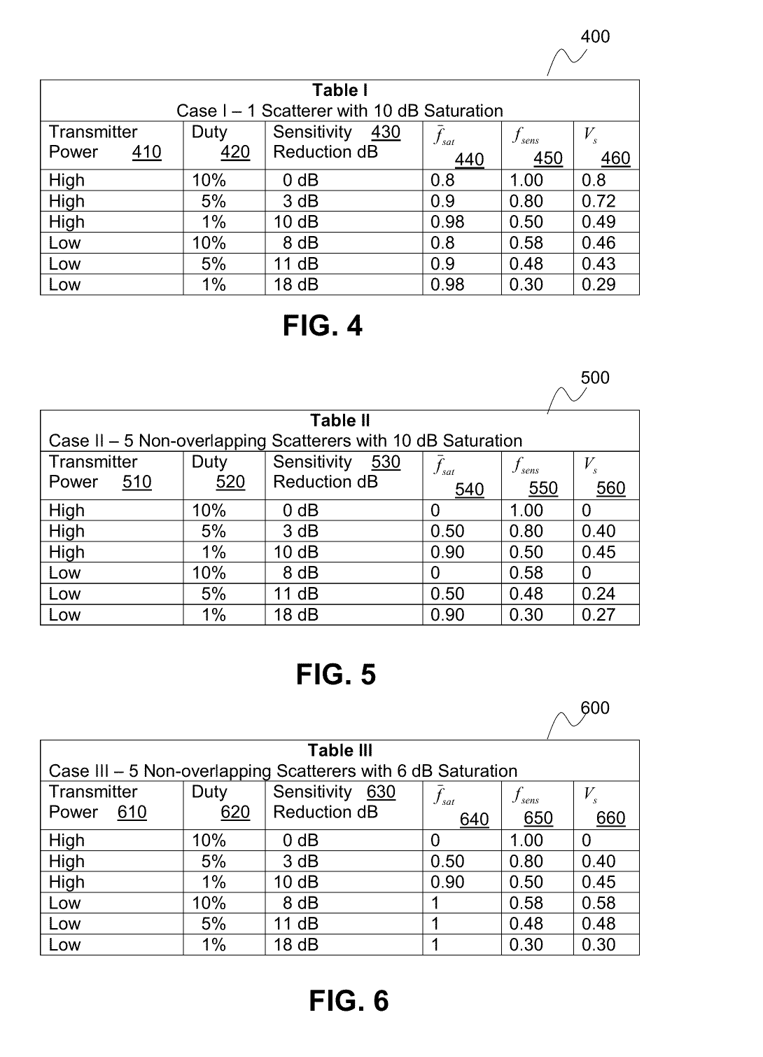

Given, the hypothetical radar can adjust waveform duty and transmitter power there are six possible options in operating the radar. FIG. 4 shows a tabular list 400 as Table I. The columns include transmitter power 410, duty percentage 420, sensitivity reduction 430, saturation probability 440, sensitivity probability 450 and surveillance volume 460.

The tabular view 400 enables observation that optimum set up (maximum surveillance volume V_{S}) is the radar's nominal setup of high power and full duty. Under this arrangement, the radar can expect to have its surveillance volume reduced to 0.8% or 80% of its non-saturated surveillance volume. Under the conditions that the radar uses different PRFs (that minimize overlapping blind ranges), the cumulative probability of Firm track increases on every search by the radar. This is the best that the radar can perform under this situation.

The second case involves the same radar with five non-overlapping scatters whose amplitudes are 10 dB above the saturation point. After pulse compression, 100% of the range cells are affected by saturation. FIG. 5 illustrates the second case in tabular view 500 at Table II. The columns include transmitter power 510, duty percentage 520, sensitivity reduction 530, saturation probability 540, sensitivity probability 550 and surveillance volume 560.

As in the first case, reducing transmitter power does not eliminate saturation because the transmitter power reduction is only 8 dB. To eliminate saturation the transmitter power must drop by more than 10 dB. The optimum arrangement for the radar can be determined from Table II, which shows a preferred setting of 1% duty and high power. The surveillance volume now decreases to 0.45% or 45% of its non-saturated volume.

The third case is similar to the second case except that the clutter is only 6 dB above the saturation threshold. FIG. 6 illustrates the third case in tabular view 600 at Table III. The columns include transmitter power 610, duty percentage 620, sensitivity reduction 630, saturation probability 640, sensitivity probability 650 and surveillance volume 660. Therefore, reducing the transmitter power by 8 dB will cause all saturation to disappear. The tabular view 600 in Table III illustrates this case and shows that the optimum setting is 10% duty with low power output. This yields surveillance volume of Vₛ=0.58.

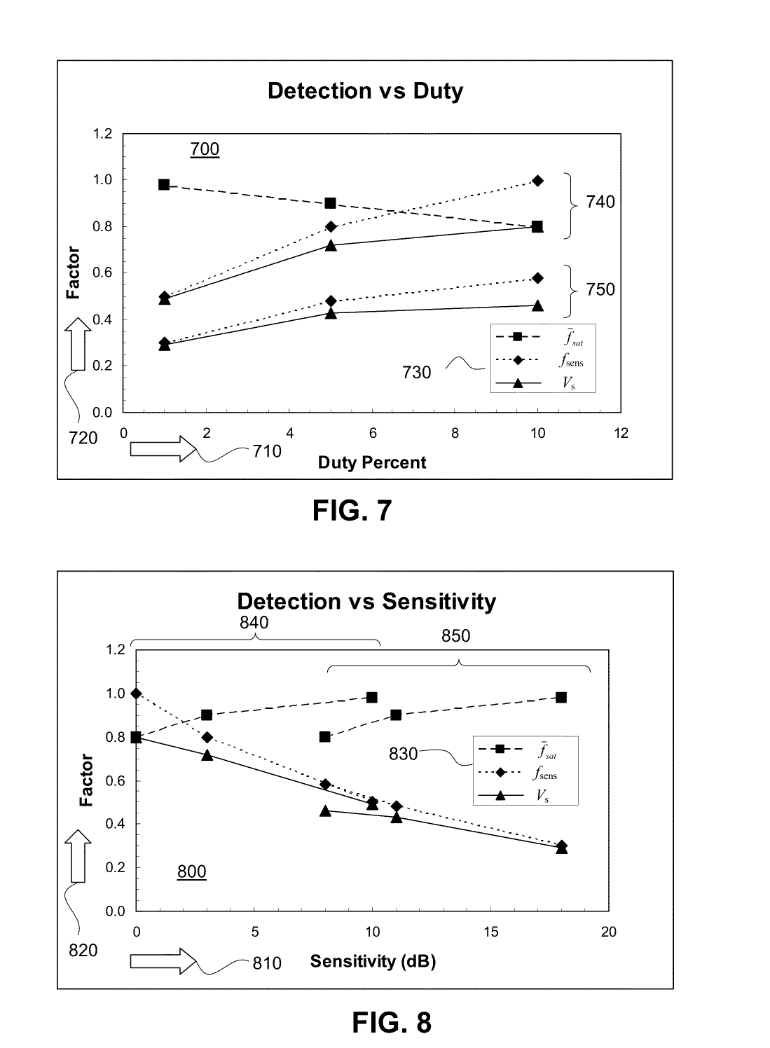

The three aforementioned example cases can be visualized by accompanying plots. FIG. 7 shows a plot 700 of detection versus duty for one scatterer with 10 dB saturation from Table I. The abscissa 710 identifies duty percentage of radar activity. The ordinate 720 denotes the performance factor identified in the legend 730.

In particular, the performance factor represents non-saturation probability f̅ₛₐₜ by filled squares, sensitivity fₛₑₙₛ by filled diamonds, and surveillance volume Vₛ by filled triangles. The symbols as identified in the legend 730 are also incorporated in subsequent plots. The sensitivity and surveillance volume points can be separated into two groups based on transmission power: high 740 and low 750 (at 8 dB reduction from high), non-saturation probability being insensitive to transmission power.

FIG. 8 shows a plot 800 of detection versus sensitivity for one scatterer with 10 dB saturation from Table I. The abscissa 810 identifies sensitivity reduction. The ordinate 820 denotes the performance factor identified in the legend 830. The points can be separated into high 840 and low 850 transmission power categories, which shifts sensitivity.

As can be observed, non-saturation diminishes as duty percentage rises. However surveillance volume maximizes at the higher duty due to increasing sensitivity with duty rising for both transmitter power levels. Similarly, non-saturation increases with increased sensitivity reduction. Nonetheless, surveillance volume maximizes with minimum sensitivity reduction in response to sensitivity probability.

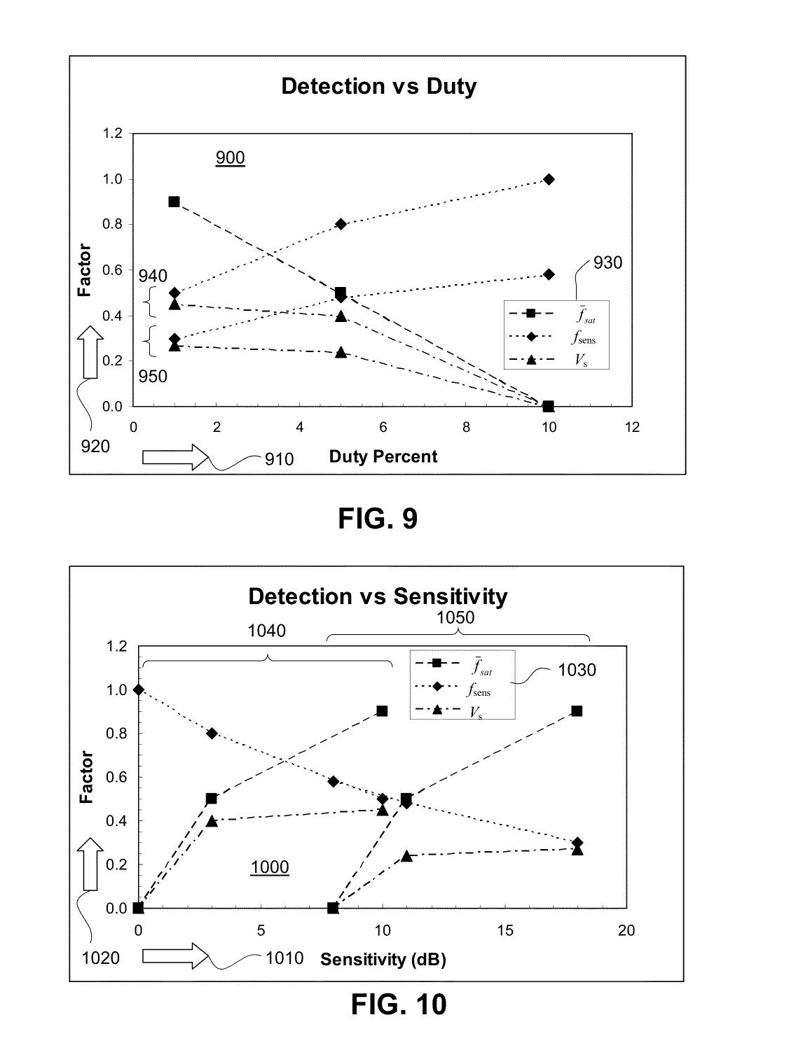

FIG. 9 shows a plot 900 of detection versus duty for five non-overlapping scatterers with 10 dB saturation from Table II. The abscissa 910 identifies duty percentage of radar activity. The ordinate 920 denotes the performance factor identified in the legend 930. The points can be separated into high 940 and low 950 transmission power categories for the sensitivity and surveillance volume.

FIG. 10 shows a plot 1000 of detection versus sensitivity for five non-overlapping scatterers with 10 dB saturation from Table II. The abscissa 1010 identifies sensitivity reduction. The ordinate 1020 denotes the performance factor identified in the legend 1030. The points can be separated into high 1040 and low 1050 transmission power categories, which shifts sensitivity.

For the additional scatterers, non-saturation increases dramatically as duty percentage is reduced, whereas sensitivity diminishes. The resulting surveillance volume as a product of these probabilities maximizes at the lower. Similarly, non-saturation increases with increased sensitivity reduction. Correspondingly, surveillance volume maximizes with maximum sensitivity reduction in contrast to sensitivity probability.

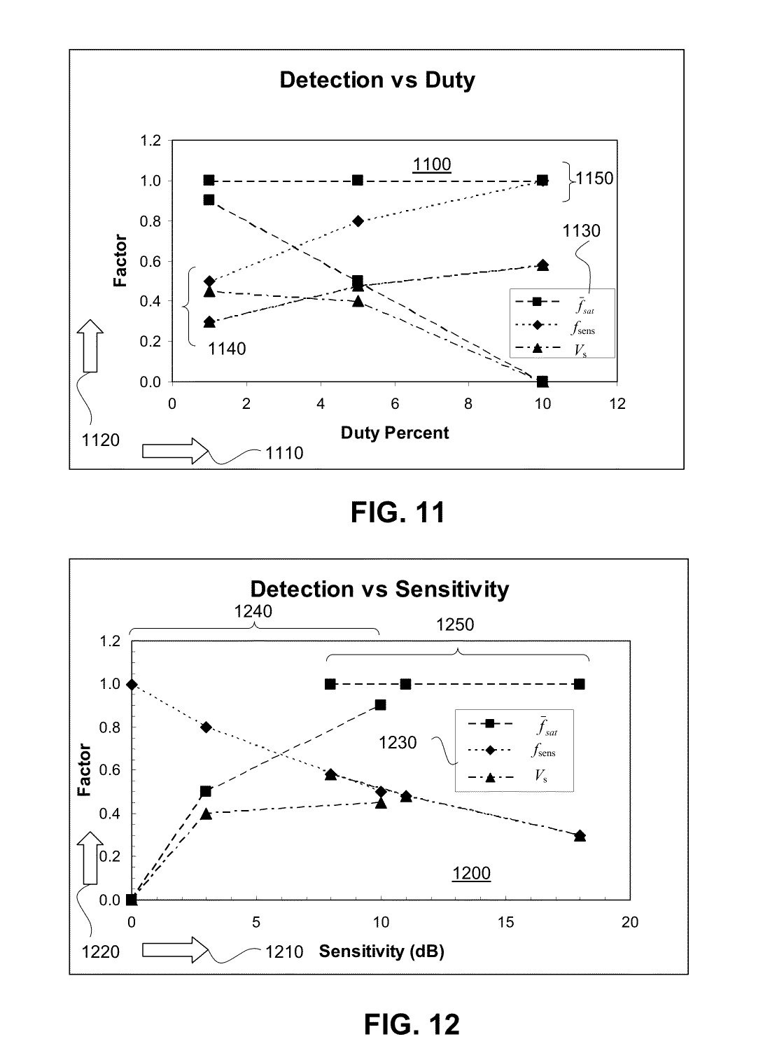

FIG. 11 shows a plot 1100 of detection versus duty for five non-overlapping scatterers with 6 dB saturation from Table III. The abscissa 1110 identifies duty percentage of radar activity. The ordinate 1120 denotes the performance factor identified in the legend 1130. The points can be separated into high 1140 and low 1150 transmission power categories for the sensitivity and surveillance volume.

FIG. 12 shows a plot 1200 of detection versus sensitivity for five non-overlapping scatterers with 6 dB saturation from Table III. The abscissa 1210 identifies sensitivity reduction. The ordinate 1220 denotes the performance factor identified in the legend 1230. The points can be separated into high 1240 and low 1250 transmission power categories, which shifts sensitivity.

For reduced saturation with the five scatterers, non-saturation rises with reduced duty percentage at high transmitter power but remains optimally flat at lower power, whereas sensitivity diminishes with duty reduction at both power levels. The resulting surveillance volume as a product of these probabilities peaks at 8 dB depending on power level. Similarly, non-saturation increases with increased sensitivity reduction. Correspondingly, surveillance volume maximizes with maximum sensitivity reduction in contrast to sensitivity probability.

With the additional scatterers subject to diminished saturation, non-saturation increases dramatically as duty percentage rises, whereas sensitivity diminishes. The resulting surveillance volume as a product of these probabilities maximizes at the lower. Similarly, non-saturation increases with increased sensitivity reduction. Correspondingly, surveillance volume maximizes with maximum sensitivity reduction in contrast to sensitivity probability.

Furthermore, this algorithm is very simple and will not stress computing resources of existing radars. This process can be implemented automatically by computer software and/or hardwired in electronic hardware. The alternatives to using this algorithm are limited. Currently, there two approaches to this problem. The first is to apply sensitivity reductions in an ad hoc manner that could seriously degrade the performance of the radar. The second method described in patent EP 2342581 for Clutter reduction in detection systems. This approach requires two receive beams and switching within an IPP. This technique is more complex in terms of radar equipment and degrades the radar's ability to cancel clutter due to switching within the IPP.

In accordance with a presently preferred embodiment of the present invention, the components, process steps, and/or data structures may be implemented using various types of operating systems, computing platforms, computer programs, and/or general purpose machines. In addition, those of ordinary skill in the art will readily recognize that devices of a less general purpose nature, such as hardwired devices, or the like, may also be used without departing from the scope and spirit of the inventive concepts disclosed herewith. General purpose machines include devices that execute instruction code. A hardwired device may constitute an application specific integrated circuit (ASIC) or a field programmable array (FPGA) or other related component.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A computer-implemented method for maximizing surveillance volume in a radar system, said method comprising:
determining non-saturation range probability f̅ₛₐₜ for each available radar setting option, said setting option corresponding to a radar pulse duration and interval therebetween;
determining sensitivity probability fₛₑₙₛ for each corresponding radar setting option;
calculating surveillance volume from multiplying said saturation range probability by said sensitivity probability as Vₛ= f̅ₛₐₜfₛₑₙₛ for each available radar setting option; and
selecting said radar setting option that maximizes Vₛ hence maximizing said surveillance volume.

2. The method according to claim 1, wherein the radar system adjusts duty cycle to maximize said surveillance volume.

3. The method according to claim 1, wherein the radar system adjusts transmission power to maximize said surveillance volume.

4. The method according to claim 1, wherein the radar system adjusts sensitivity reduction to maximize said surveillance volume.
